(19) United States
(12) Patent Application Publication
(10) Pub. No.: US 2010/0242598 A1
(43) Pub. Date: Sep. 30, 2010

(54) Arrangement to Determine a Static Moment of a Blade

(76) Inventor: David Stien Pedersen, Aalborg (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/730,524

(22) Filed: Mar. 24, 2010

(30) Foreign Application Priority Data
Mar. 25, 2009 (EP) 09004278.9

(51) Int. Cl. G01M 1/12

(52) U.S. Cl. 73/456

(57) ABSTRACT

A root-end of the blade is connectable to a fixation unit which is pivotably mounted around a first reference-point. A first static moment of the fixation unit without the blade connected is determined in reference to a first reference-point, while the first static-moment is acting on the fixation-unit at the first distance. A second static-moment of the fixation unit and the connected blade is determined at a second distance in reference to the first reference-point, while the second distance is allocated to a cross-section of the blade. The first and the second static-moment are used to calculate the static-moment of the blade.

### CROSS REFERENCE TO RELATED APPLICATIONS

This application claims priority of European Patent Office application No. 09004278.9 EP filed Mar. 25, 2009, which is incorporated by reference herein in its entirety.

### FIELD OF INVENTION

The invention relates to an arrangement to determine a static moment of a blade, especially of a wind-turbine-blade.

### BACKGROUND OF INVENTION

A wind-turbine rotor has to be balanced to ensure the lifetime of the wind-turbine. For this each blade, which has to be mounted on a hub of the rotor, has to affect the hub with the same gravity-moment or static-moment.

If the blades differ in their static-moments the wind turbine is affected by the rotating blades irregular. Instabilities result in extraordinary wear of wind-turbine-components. Over time cracks may occur on the rotor, the nacelle, the tower, the bearing and also to other primary components of the wind turbine because of the unbalanced mass of the rotating blades. In worst case the lifetime of the wind-turbine is reduced by the unbalanced rotor.

If the blades do not show the same gravity- or static-moment small weights are added to the blades to establish an equilibrium. Usually the weights are located and fixed inside the blades.

The static-moment of a wind-turbine-blade can be determined by weighing the blade, where two scales are used. A first scale is placed at the root-end of the blade and a second scale is placed at the tip-end of the blade.

For this the blade has to be placed equally and accurately on the two scales. The two scales have to perform the weight-measurement of the huge blade very accurately, so they are very expensive.

The distance between the first and the second scale is measured, while this has to be accurate and within the precision of only a few millimeter. To ensure the accurate distance the weighing-systems are typically fixed by bolts at the floor. This leads to an inflexible weighing-system—so valuable production-area is allocated constantly, even if no blade-weighing needs to be performed.

It is known from U.S. Pat. No. 4,078,422 to measure the static-moment of a rotor blade by supporting and measuring the weight of a rotor blade in at least two positions. Here the same problems as stated above will occur.

It is known from RU 2224 228 to measure the static-moment of a blade by placing the blade on a rocking lever. The rocking lever is balanced in advance. The lever is connected through a force-transmitting rod to a weight measurement device. The static moment of the blade is partially compensated by a force put on the rocking lever. This system needs also great areas, as a long lever is needed around half of the length of the blade.

An exact placement of the blade is needed and this is difficulty to achieve.

### SUMMARY OF INVENTION

It is therefore the aim of the invention, to provide an improved arrangement to determine the static-moment of a blade of a wind-turbine, which allows to determine the static-moment with less expensive efforts.

This problem is solved by the features of independent claims. Preferred embodiments of the invention are subject of the dependent claims.

According to the invention a fixation-unit is used to hold the blade.

The fixation-unit shows a first reference-point, which is used as a center of rotation of the fixation-unit.

The fixation-unit shows a second reference-point, which has a predetermined distance to the first reference-point.

In a preferred embodiment the distance between the two reference-points is equal to a radius of a hub, which is planned to carry the blade later at a wind-turbine-site.

The second reference-point is part of a cross-sectional-area of the fixation-unit, while this area is orthogonal to the longitudinal-axis and while this cross-sectional-area is prepared and used to carry the root-end of the blade.

Because of this arrangement the blade and the fixation-unit can be rotated around the first reference-point.

A third reference-point show a certain distance to the first reference-point. The third reference-point is part of a cross-sectional-area of the blade, which is orthogonal to the longitudinal-axis of the blade. At the position of the third reference-point the weight of the blade is determined.

The distance between the first reference-point and the second reference-point may be measured with a high precision by help of a laser or may be predetermined by help of a hole or marks along a testing-line for example.

The measured weight of the blade is used to calculate the static-moment of the blade with respect to the distance between the first and the third reference-point.

In a preferred embodiment the fixation-unit holds the blade in a horizontal position. In this case the longitudinal-axis of the blade is mainly parallel to the ground.

The fixation-unit is formed as a special bracket, to allow the connection of the root-end of the blade. As stated above this bracket ensures that the root-end of the blade show a distance to the center of rotation, which is equal to the distance from the root-end to the centre of a hub, planned to be used at the wind-turbine.

The invention allows to determine the static-moment of a blade in an easy and cheap manner.

The invention allows to reuse the area, which is needed for the determination of the static-moment, for other purposes as its components can be removed easily when the measurement is done.

The used equipment is flexible and can be used in different environments.

The used equipment can also be used for blades showing different lengths, so a standardized measurement equipment is established.

The equipment allows to be used alternating between different production lines or even to be used at a harbor or directly to be used on a wind-turbine-site.

The invention allows to reduce tolerances in the weighing process as less components are needed compared with the state of the art. Therefore a resulting chain of tolerances are reduced.

### BRIEF DESCRIPTION OF THE DRAWINGS

The invention is described now in more detail by help of a FIGURE.

FIG. 1 shows the determination of a static-moment of a blade BL according to the invention.

### DETAILED DESCRIPTION OF INVENTION

A fixation-unit FU is used to hold the blade BL in a mainly horizontal position. So the longitudinal-axis LA of the blade BL is mainly parallel to the ground GND.

The fixation-unit FU shows a first reference-point RP1, which is used as a center of rotation of the fixation-unit. So the fixation unit FU is mounted pivotable around the first reference-point RP1.

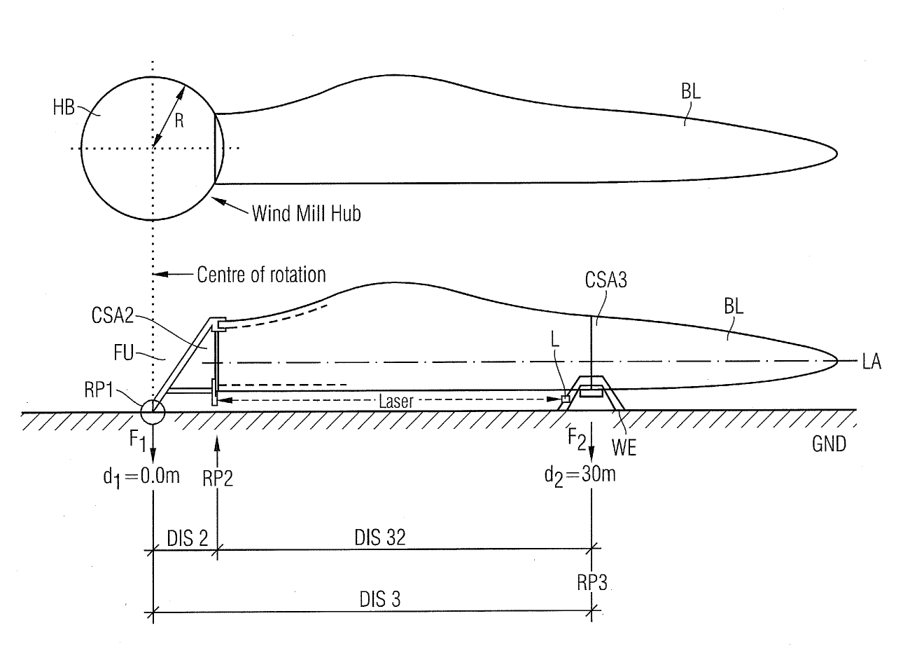

The fixation-unit FU shows a second reference-point RP2, which has a predetermined distance DIS2 to the first reference-point RP1. The distance DIS2 between the two reference-points is equal to a radius R of a hub HB, which is planned to carry the blade BL later at a wind-turbine-site (please refer to the sketch shown in top of FIG. 1).

The second reference-point RP2 is part of a cross-sectional-area CSA2 of the fixation-unit FU, while this area CSA2 is orthogonal to the longitudinal-axis LA and while this cross-sectional-area CSA2 is prepared and used to carry the root-end of the blade BL.

Because of this arrangement the blade BL and the fixation-unit FU, which is connected with the blade BL, can be rotated around the first reference-point RP1 by a certain angle.

A third reference-point RP3 show a certain distance DIS3 to the first reference-point RP1. The third reference-point RP3 is part of a cross-sectional-area CSA3 of the blade, which is orthogonal to the longitudinal-axis LA of the blade BL. At the position of the third reference-point RP3 the weight WE of the blade BL is determined by help of a scale.

The distance DIS2 between the first reference-point RP1 and the second reference-point RP2 may be measured with a high precision. This is done by help of a laser or by help of marks or holes along a testing-line for example.

The measured weight WE of the blade BL is used to calculate the static-moment of the blade with respect to the distance DIS3 between the first reference-point RP1 and the third reference-point RP3.

Because the blade BL is supported by the fixation-unit FU as described above, the total static-moment of the blade BL results from a contribution of weights at the first reference-point RP1, at the second reference point RP2 and at the third reference-point RP3.

Each of these weights result in a turning-moment, all of them contributes to the resulting static-moment of the blade BL.

A first turning-moment, which is acting at the position of the first reference- point RP1, is “0 Nm” as the distance to the center of rotation is “0 m”.

A second turning-moment, which is acting at the position of the second reference-point RP2, needs to be calculated only one times. The moment depends on the distance DIS2 between the first reference-point RP1 and the second reference-point RP2 and on the weight, which is acting at the second reference-point RP2 towards the ground GND.

A third turning-moment, which is acting at the position of the third reference- point RP3, needs to be determined. It depends on the distance DIS3 between the first reference-point RP1 and the third reference-point RP3 and on the weight WE, which is acting at the third reference-point RP3 towards the ground GND. This weight WE is measured by only one scale, while the distance DIS3 is measured directly or is calculated.

For example the distance DIS32 between the second reference-point RP2 and the third-reference-point RP3 is measured with a high accuracy by help of a laser. The needed sender and receiver for this are mounted as components at predetermined positions nearby the reference-points RP2, RP3. The distance DIS2 is known by the scale and shape of the fixation-unit FU. So it is possible to calculate the distance DIS3.

In a preferred embodiment a laser-component is integrated into a leg L of the scale, which is positioned at the third reference-point RP3. In this case another laser-component is located as close as possible to the root-end of the blade BL—as it is shown here.

It is possible to measure the distance DIS3 between the first reference-point RP1, which is used as center of rotation, and the third reference-point RP3 directly as described above.

Instead of a laser-measurement it is also possible to lock the centre of rotation RP1 and the position of the scale (at RP3) on the floor by a permanent sign. Or a bracket, which is used to carry the scale, is locked by holes in the floor on a certain position.

In a preferred embodiment the fixation-unit FU and/or the movable scale show wheels to allow the components to be moved to a blade if needed.

1.-5. (canceled)

6. An arrangement to determine a static moment of a blade, comprising:
a first reference point;
a fixation unit pivotably mounted around the first reference-point;
a root-end of the blade connectable to the fixation-unit at a connection-area of the fixation unit;
a first static moment of the fixation-unit without the blade connected is determined in reference to the first reference-point, the first static moment is acting on the fixation unit at a first distance in reference to the first reference point, the first distance is at the connection area; and
a second static moment of the fixation unit and the connected blade is determined at a second distance in reference to the first reference point , the second distance is at a cross-section area of the blade, wherein
the static moment of the blade calculated using the first and second static moments.

7. The arrangement according to claim 6, wherein
the first distance is equal to a radius of a hub to which the blade will be later attached.

8. The arrangement according to claim 7, wherein
a laser is used to measure the first or second distance in order to determine the first or the second static moment is measured by help of laser components.

9. The arrangement according to claim 7, wherein
a laser is used to measure the first and second distance in order to determine the first and the second static moment is measured by help of laser components.

10. The arrangement according to claim 7, wherein
a weight to determine the first and/or second static moment is measured via a scale.

11. The arrangement according to claim 10, wherein
the weight of the second static moment is determine via the scale at the cross-section area of the blade which is at the second distance from the first reference point.

12. The arrangement according to claim 10, wherein
the scale is movable by wheels in order to be movable to the blade.

13. The arrangement according to claim 12, wherein
the fixation unit is movable by wheels in order to be movable to the blade.

14. The arrangement according to claim 7, wherein
the fixation unit is movable by wheels in order to be movable to the blade.

15. A method to calculate a static moment of a blade, comprising:
providing a fixation unit that is pivotably mounted around a first reference point and which provides a connection area to which a root end of the blade is connectable;
measuring a first longitudinal distance from the first reference point to the connection area;
measuring a second longitudinal distance from the first reference point to a cross-section area of the blade;
determining, without the blade connected, a first static moment of the fixation unit in reference to the first reference point, the first static moment is acting on the fixation unit at the connection area;
determining, with the blade connected, a second static moment of the fixation unit in reference to the second reference point; and
calculating the static moment of the blade using the determined first and second static moments.

16. The method according to claim 15, wherein
the first longitudinal distance is equal to a radius of a hub to which the blade will be later attached.

17. The method according to claim 15, wherein
the measuring the first longitudinal distance is via a laser.

18. The method according to claim 15, wherein
the measuring the second longitudinal distance is via a laser.

19. The method according to claim 15, wherein
a weight to determine the second static moment is determined at the cross-section area of the blade.

20. The method according to claim 19, wherein
the weight is measured via a scale.

21. The method according to claim 15, wherein
a weight to determine the first and/or the second static moment is measured via a scale.

22. The method according to claim 21, wherein
the scale is movable by wheels in order to be movable to the blade.

23. The method according to claim 22, wherein
the fixation unit is movable by wheels in order to be movable to the blade.

24. The method according to claim 15, wherein
the fixation unit is movable by wheels in order to be movable to the blade.
